(19) United States
(12) Patent Application Publication
(10) Pub. No.: US 2026/0342564 A1
(43) Pub. Date: Oct. 29, 2026

(54) SYSTEMS AND METHODS FOR RELATIVISTIC ZERO-KNOWLEDGE PROOF-BASED MESSAGE AUTHENTICATION

(71) Applicant: JPMORGAN CHASE BANK, N.A., New York, NY (US)

(72) Inventors: Wen Yu KON, Singapore (SG); Yao MA, Guangdong (CN); Ignatius William PRIMAATMAJA, Singapore (SG); Kaushik CHAKRABORTY, Singapore (SG); Ci Wen LIM, Singapore (SG); Marco PISTOIA, New York, NY (US)

(21) Appl. No.: 19/193,006

(22) Filed: Apr. 29, 2025

(51) Int. Cl. H04L 9/14

(52) U.S. Cl. CPC H04L 9/14

(57) ABSTRACT

A method may include: a first verifier receiving, from a first prover, a message that is encoded into a codeword comprising a plurality of bits using a codebook; for each bit in the codeword, one of the plurality of bits of the codeword is a time indicator bit that sets an earlier response time or a later response time; for a number of rounds: sending a first challenge to the first prover; receiving a first response to the first challenge at a timing based on the time indicator bit; and checking that the first response and that a time of receipt of the first response are valid; identifying a received time indicator bit from the first receipt times of all rounds; generating a received codeword using the received time indicator bits; decoding the received codeword using the codebook; and verifying that the decoded message matches the received message.

### BACKGROUND OF THE INVENTION

### 1. Field of the Invention

Embodiments relate to systems and methods for relativistic zero-knowledge proof-based message authentication.

### 2. Description of the Related Art

Messages sent between any sender and receiver may run the risk of being tampered, and message authentication was introduced to address the issue. Message authentication allows a receiver to verify the origin and integrity of the message, i.e., that the message originated from the sender and has not been tampered. Currently, there are two main ways message authentication is performed: using private key cryptography or using public key cryptography.

In using private key cryptography, both the sender and the receiver must pre-share a secret key. When sending the message, the sender includes a hash of the message with the secret key, for which the receiver can use to check for tampering and verify the origin.

For public key cryptography, the sender holds a private key only known to him, and there is a corresponding public key that the receiver knows. When sending the message, the sender includes a signature by signing the message with his secret key, for which the verifier (or any party) can verify the origin and check for tampering using the public key.

In both cases, any adversary without knowledge of the secret key is unable to impersonate the sender or tamper the message without being detected. Both, however, have limitations. Examples of such limitations include the need to pre-share secret keys (e.g., for private key cryptography, the need for pre-shared keys limit the applications it can be used for. For instance, it requires the bank to share the PIN number of a customer's card with a separately managed ATM system—which can compromise security if the ATM system provider is malicious.); vulnerability to quantum adversaries (e.g., public key cryptography-based message authentication relies on a weaker class of computational hardness assumption and may be vulnerable to quantum adversaries); heavy communication requirements (e.g., the signatures in public key cryptography typically is larger in size compared to hashes of private key cryptography, and the size is increased when transiting to safer post-quantum public key cryptography); compromised security (e.g., every message authentication run can leak tiny amounts of information of the secret key, which may result in compromised security if the secret keys are not refreshed at regular intervals); etc.

### SUMMARY OF THE INVENTION

Systems and methods for relativistic zero-knowledge proof-based message authentication are disclosed. In one embodiment, a method may include: receiving, by a first verifier, a message from a first prover, wherein the message may be encoded into a codeword using a codebook, wherein the codeword may include a plurality of bits; for each bit in the codeword, one of the plurality of bits of the codeword is a time indicator bit, wherein the time indicator bit sets a response time, wherein the response time may include an earlier response time or a later response time; for a number of rounds: sending, by the first verifier, a first challenge to the first prover; receiving, by the first verifier and from the first prover, a first response to the first challenge at a timing based on the time indicator bit; and checking, by the first verifier that the first response is valid and that a first receipt time of the first response is valid; identifying, by the first verifier, a received time indicator bit from the first receipt times of all rounds; generating, by the first verifier, a received codeword using the received time indicator bits; decoding, by the first verifier, the received codeword using the codebook into a decoded message; and verifying, by the first verifier, that the decoded message matches the received message.

In one embodiment, the number of rounds may be based on a security parameter.

In one embodiment, the security parameter may be based on a probability of an adversary passing timing and validity checks for the first responses.

In one embodiment, the step of checking, by the first verifier that the first response is valid and that a time of receipt of the first response is valid may include: jointly checking, by the first verifier and a second verifier, that the first response and a second response to a second challenge from second prover are valid and that a time of receipt of the first response and the second response are valid.

In one embodiment, the first challenge and the second challenge are based on a public identification key for which the first prover and the second prover share a private identification key.

In one embodiment, the first response may include a first encrypted secret based on the private identification key and the first challenge, and the second response may include a second encrypted secret based on the private identification key and the second challenge.

In one embodiment, a validity of the time of receipt of the first response and the time of receipt of the second response may be based on a distance between the first prover and the second prover.

In one embodiment, the first verifier identifies the received time indicator bit from the first receipt times of all rounds and the earlier and later response times

According to another embodiment, a system may include: a first prover; a first verifier in communication with the first prover; a second prover; and a second verifier in communication with the second prover. The first prover sends a message to the first verifier; the first prover encodes the message into a codeword using a codebook, wherein the codeword may include a plurality of bits; for each bit in the codeword: the first prover selects one of the plurality of bits of the codeword as a time indicator bit, wherein the time indicator bit sets a response time, wherein the response time may include an earlier response time or a later response time; for a number of rounds: the first verifier may be configured to send a first challenge to the first prover; the second verifier may be configured to send a second challenge to a second prover; the first prover may be configured to send a first response to the first challenge to the first verifier at a timing based on the time indicator bit; the second prover may be configured to send a second response to the second challenge to the second verifier; and the first verifier and the second verifier are configured to jointly check that the first response and the second response are valid and that a first receipt time of the first response and the second response are valid; the first verifier may be configured to identify a received time indicator bit from the first receipt times of all rounds; the first verifier may be configured to generate a received codeword using the received time indicator bits; the first verifier may be configured to decode the received codeword using the codebook into a decoded message; and the first verifier may be configured to verify that the decoded message matches the received message.

In one embodiment, the number of rounds may be based on a security parameter.

In one embodiment, the security parameter may be based on a probability of an adversary passing timing and validity checks for the first responses and the second responses.

In one embodiment, the first challenge and the second challenge are based on a public identification key for which the first prover and the second prover share a private identification key.

In one embodiment, the first response may include a first encrypted secret based on the private identification key and the first challenge, and the second response may include a second encrypted secret based on the private identification key and the second challenge.

In one embodiment, a validity of the time of receipt of the first response and the time of receipt of the second response may be based on a distance between the first prover and the second prover.

In one embodiment, the first verifier may be configured to identify the received time indicator bit from the first receipt times of all rounds and the earlier and later response times.

According to another embodiment, a method may include: sending, by a first prover, a message to a first verifier; encoding, by a first prover, the message into a codeword using a codebook, wherein the codeword may include a plurality of bits; for each bit in the codeword: selecting, by the first prover, one of the plurality of bits of the codeword as a time indicator bit, wherein the time indicator bit sets a response time, wherein the response time may include an earlier response time or a later response time; for a number of rounds, wherein the number of rounds may be based on a security parameter: receiving, by the first prover, a first challenge from the first verifier; sending, by the first prover, a first response to the first challenge to the first verifier at a timing based on the time indicator bit, wherein the first verifier checks that the first response is valid and that a first receipt time of the first response is valid; wherein the first verifier may be configured to identify a received time indicator bit from the first receipt times of all rounds; the first verifier may be configured to generate a received codeword using the received time indicator bits, to decode the received codeword using the codebook into a decoded message, and to verify that the decoded message matches the received message.

In one embodiment, the first challenge may be based on a public identification key for which the first prover shares a private identification key with a second prover, and wherein the first response may include a first encrypted secret based on the private identification key and the first challenge.

In one embodiment, the first verifier may be configured to identify the received time indicator bit from a sum of the first receipt times of all rounds and the earlier response time.

In one embodiment, the first verifier may be configured to identify the received time indicator bit from the first receipt times of all rounds and the earlier and later response times.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 illustrates a system for relativistic zero-knowledge proof-based message authentication according to an embodiment;

FIGS. 2A, 2B, and 2C illustrate a method for relativistic zero-knowledge proof-based message authentication according to an embodiment;

FIG. 3 depicts an exemplary computing system for implementing aspects of the present disclosure.

### DETAILED DESCRIPTION OF PREFERRED EMBODIMENTS

Embodiments relate to systems and methods for relativistic zero-knowledge proof-based message authentication.

Embodiments may implement a message authentication protocol based on relativistic zero-knowledge proofs (RZKPs) that allows messages sent from a prover to a verifier to be authenticated (typically from client to the server). This capitalizes on an inherent property of any response signal from the prover—the timing of the response. By encoding the message (or a codeword) into the timing of the response, the verifier may use the content of the response to certify the prover as the origin, and may then use the timing of that response to determine the codeword or message. Since any adversary seeking to tamper with the timing of the response can only delay the timing but not speed up the timing, there are limited avenues for the adversary to cheat. This provides the security for the digital signature scheme. Exemplary details of RZKP protocols are provided in P. Alikhani, et al., “Experimental relativistic zero-knowledge proofs,” Nature 599, 47-50 (2021), C. Crépeau, et. al. “Practical Relativistic Zero-Knowledge for NP,” In 1st Conference on Information-Theoretic Cryptography (ITC 2020) Leibniz International Proceedings in Informatics (LIPIcs), Volume 163, pp. 4:1-4:18, Schloss Dagstuhl—Leibniz-Zentrum für Informatik (2020), and A. Chailloux, et al., “Relativistic (or 2-Prover 1-Round) Zero-Knowledge Protocol for NP Secure Against Quantum Adversaries,” In Advances in Cryptology—EUROCRYPT 2017 Lecture Notes in Computer Science, Volume 10212. Springer, Cham (2017), the disclosures of which are hereby incorporated by reference in their entireties.

In embodiments, the receivers need not share secret keys with the senders. It relies on a stronger class of computational hardness assumption (NP-hardness), while requiring smaller message sizes compared to signatures. Moreover, with zero-knowledge guarantees against even unbounded computational adversaries, the secret keys can remain safe for much longer durations without the need for regular refresh.

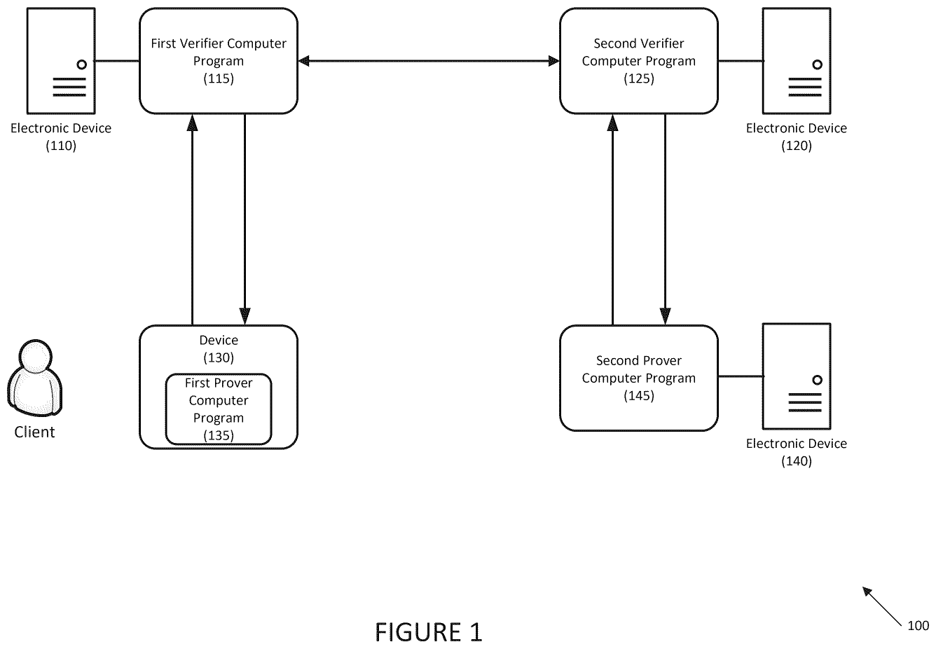

Referring to FIG. 1, a system for relativistic zero-knowledge proof-based message authentication is disclosed according to an embodiment. System 100 may include first verifier computer program 115 executed by electronic device 110, first prover computer program 135 executed by device 130, second verifier computer program 125 executed by electronic device 120, and second prover computer program 145 executed by electronic device 140. Electronic device 110 and device 130 may be located at a first location, and electronic device 120 and electronic device 140 may be located at a second location.

The pairs of provers and verifiers may be well-separated and have good synchronization (e.g., the times of the internal clock of electronic device 120 and the internal clock of electronic device 110 are identical or very close).

For example, first verifier computer program 115 may be executed by a terminal, such as an automated teller machine, a point-of-sale terminal, an access control system, etc. First prover computer program 135 may be executed by a transaction card, such as a credit card, an access card, etc., may be a person seeking to access a resource via first verifier computer program 115 (e.g., access ATM services, an area, information, etc.), may be a computer program executed by a user electronic device (e.g., a computer, a smart device, an Internet of Things appliance, etc.). First prover computer program 135 may include computational capability, such as read/write ability, as well as the ability to perform simple cryptographical computations.

Electronic device 120 may be a backend for electronic device 110, such as an ATM server or backend.

Device 130 may be a hardware device, such as a device that includes non-volatile memories for storing client and user authentication information (e.g., a PIN, a biometric, etc.), as well as private identification keys. It may further include a processor that may receive the user authentication information to authenticate a user, may read and forward client information and provide the client information, such as the client's address, to first verifier computer program 115, and may read the private identification key and generate encrypted secrets to be used in the protocol. Because the hardware device needs to respond to first verifier computer program 115 within a small window of time, the communication medium, reading of private identification key, and generation of encrypted secrets should be low latency.

Device 130 may be associated with a client, such as an individual seeking to interact with the electronic device on which first prover computer program 135 is executed.

Second prover computer program 145 may be associated with first prover computer program 135, such as an issuer of a credit card, an access card, a mobile application, etc. and may share an identification key, such as a personal identification number (PIN) or other information that may be easily verifiable.

Device 130 and electronic device 140 may be located some distance apart. For example, if device 140 is a credit card that is attempting to use first verifier computer program 115, the location electronic device 110 may be used as the location of first prover computer program 135. In another embodiment, a location device 130 may be used for the location of first prover computer program 135.

First prover computer program 135 may initiate an interaction with first verifier computer program 115. For example, first prover computer program 135 may send a message to first verifier computer program 115, after which first verifier computer program 115 may send a request for the message to be authenticated to first prover computer program 135.

First prover computer program 135 and second prover computer program 145 may both share a private identification key, such as a label, a number, a solution to a problem, that is based on a public identification key.

First verifier computer program 115 may present a challenge to first prover computer program 135 at a first challenge time. The challenge may be based on a public identification key. First prover computer program 135 may provide a first response, such as a first encrypted secret based on the private identification key in response to the challenge at a first response time. The first response may be received by first verifier computer program 115 at a first receipt time, which may be later than the first response time due to communication time between first prover computer program 135 and first verifier computer program 115.

In one embodiment, at the same time, second verifier computer program 125 may issue the same challenge, or a correlated challenge, to second prover computer program 145 at a second challenge time. For example, first prover computer program 135 and second prover computer program 145 may receive parts of the same question. Second prover computer program 145, using the private identification key, may respond to the challenge with a second response, such as a second encrypted secret, at a second response time. The second response may be received by second verifier computer program 125 at a second receipt time, which may be later than the second response time due to communication time between second prover computer program 145 and second verifier computer program 125.

When the responses are combined, first verifier computer program 115 and second verifier computer program 125 may determine whether first prover computer program 135 and second prover computer program 145 share knowledge of the private identification key.

First verifier computer program 115 and second verifier computer program 125 may exchange information such as the first and second responses, first and second challenge time, and first and second receipt time. The verifiers may confirm if the timings satisfy a threshold which may depend on the distance between the first prover computer program 135 and second prover computer program 145. For example, they can share a time check function T_{ch} which takes the first and second challenge time, and first and second receipt time as input and generates bit 1 representing that the timing check passes if the timings fall within the threshold, or generates bit 0 representing the timing check failed if the timings fall outside the threshold. Furthermore, the verifiers may confirm if the first and second responses are valid responses to the challenge. For example, they can share a verification function Ver which takes as input the first and second challenges and first and second responses and generates bit 1 representing that the validity check passes if the responses are valid and generates bit 0 representing that the validity check fails if the responses are invalid.

In one embodiment, all parties may share a publicly available codebook that maps messages into codewords of equal length, allowing all parties to encode any message into their corresponding codeword and decode any valid codeword into the corresponding message. The codebook may be appropriately chosen such that it is difficult for any adversary to change from one valid codeword to another valid codeword. The length of the codewords in the codebook may be public. Thus, the verifier will know the length of the codeword and how many runs it has to do until the end of the codeword is reached.

As used herein, a “run” includes a plurality of “rounds.” A round is related to the security of the relativistic zero-knowledge proof. A run consists of n rounds and is related to the length of the codeword—each run can only transfer one time indicator bit.

A codebook is a map between messages and codewords. The codebook may be presented as a look-up table, with a list of all possible messages and a corresponding codeword for each message. To obtain a codeword from a message, one simply has to find the entry corresponding to the message, and read out the corresponding codeword. The codebook can be pre-agreed between the provers and verifiers ahead of time, or be included as part of a standard provided by a standards organization.

In one embodiment, first prover computer program 135 may change the first response time, and the change may be detectable by the first verifier computer program 115. For example, first prover computer program 135 may choose between an earlier first response time and a later first response time, and first verifier computer program 115 may be sensitive enough to detect the difference based on the first receipt time. When first prover computer program 135 selects an earlier first response time, first verifier computer program 115 may record an earlier first receipt time, and when first prover computer program 135 selects a later first response time, the first verifier computer program 115 may record a later first receipt time.

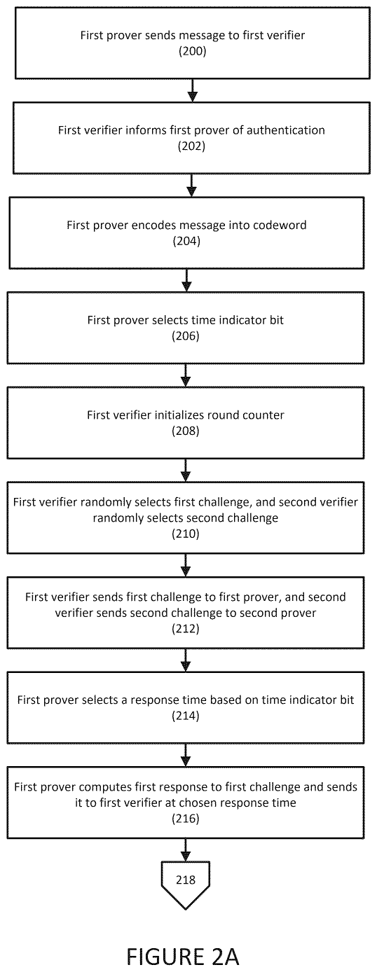

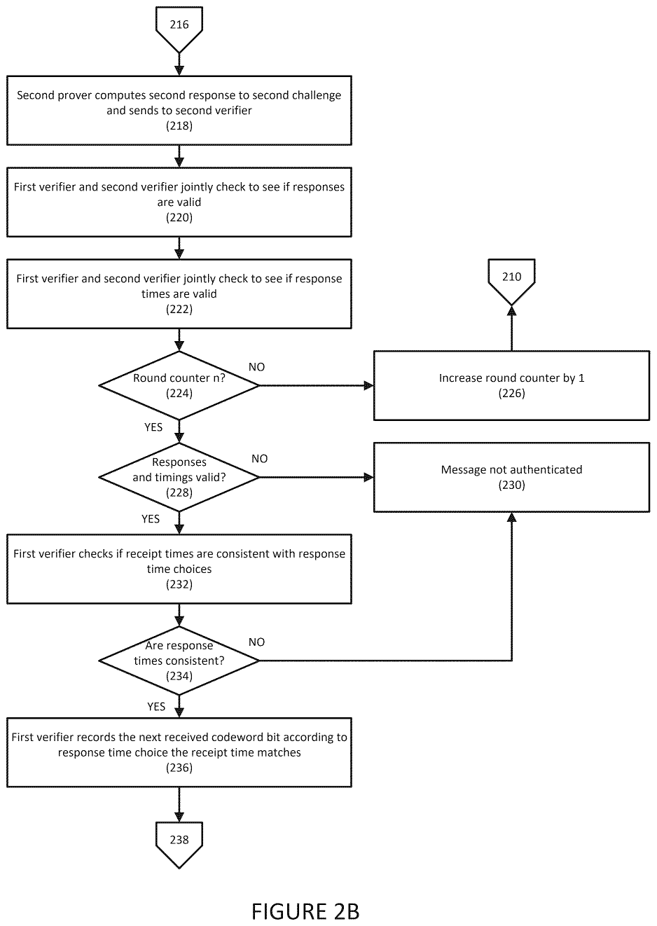

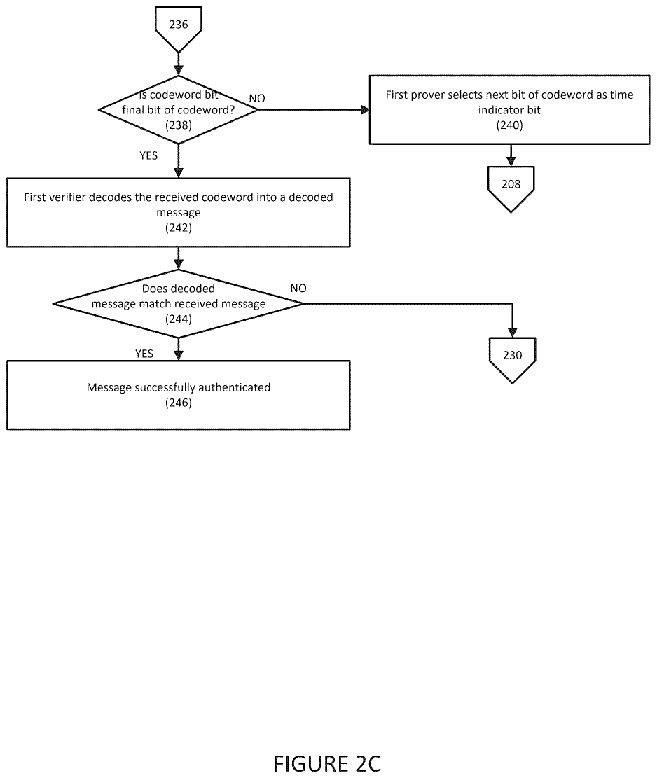

Referring to FIGS. 2A, 2B, and 2C, a method for relativistic zero-knowledge proof-based message authentication is disclosed according to one embodiment.

In step 200, a first prover may send a message to a first verifier. For example, the message may include a bitstring corresponding to an instruction for a fund transfer between bank accounts, the content of an electronic mail, or any message that the first verifier may want to ensure originates from the first prover and is not tampered with.

In step 202, the first verifier may inform the first prover of its intention to authenticate the message. For example, the first verifier may send a response containing its intent, the start time of the message authentication and the number of rounds n to the first prover.

The number of rounds may be related to the security of the relativistic zero-knowledge proof. For instance, the number of rounds n can be chosen such that the probability that an adversary can pass the timing and validity checks for n rounds is lower than a chosen security parameter.

In one embodiment, the security parameter may be chosen by the verifier. The security parameter is related to the probability that cheating provers can pass the relativistic zero-knowledge proof timing and validity checks. Thus, choosing a larger security parameter means that it is less likely for a cheating prover to pass the checks.

In step 204, a first prover may encode the message into a codeword. In one embodiment, the first prover may use a public codebook to encode the message.

In step 206, the first prover selects the first bit of the codeword as a time indicator bit. The time indicator bit, which is 0 or 1, will set the choice of first response time.

For example, if the time indicator bit is set to 0, the first response time will be the earlier response time. If the time indicator bit is set to 1, the first response time will be the later response time.

For each run (i.e., step 206 to step 238), one bit of the codeword is selected as the time indicator bit to determine the response time. For example, in the first run, the first bit of the codeword is selected as the time indicator bit, then in the second run, the second bit of the codeword is the time indicator bit, etc. This continues for multiple runs, with the bit of the codeword being updated until the end of the codeword is reached in step 238. The choice of the time indicator bit is related to the codeword, which in turn is related to the message.

In step 208, the first verifier initializes a round counter to one.

In step 210, the first verifier randomly selects a first challenge, and a second verifier randomly selects a second challenge. The challenges may be based on a public identification key for which the first and second provers share the corresponding private identification key. For example, if the public identification key is a hard constraint problem and the private identification key is the solution (i.e., assignment of variables that satisfy the constraint problem), the challenges may be requests for assignments of specific variables.

In step 212, the first verifier sends the first challenge to the first prover, and the second verifier sends the second challenge to a second prover. The second prover is necessary for RZKP security. By having two provers instead of a single one, it becomes more challenging for adversaries (dishonest provers with no knowledge of the private identification key) to pass the RZKP (e.g., timing and validity tests).

In step 214, the first prover may select a response time based on the time indicator bit. For example, if the time indicator bit is 0, the first prover may choose an earlier response time and if the time indication bit is 1, the first prover may choose a later response time.

In step 216, the first prover computes a first response to the first challenge and sends it to the first verifier at the chosen response time. The first response may be a first encrypted secret based on the private identification key in response to the first challenge. For example, if the first challenge is a request for assignments of specific variables, the response would be a masked assignment of the specific variables. The first verifier receives the first response from the first prover at a first receipt time, which the first verifier can measure using an internal clock.

In step 218, the second prover computes a second response to the second challenge and sends to the second verifier. The second response may be a second encrypted secret based on the private identification key in response to the second challenge. For example, if the second challenge is a request for assignments of specific variables, the response would be a masked assignment of the specific variables. The second verifier receives the second response from the second prover at a first receipt time, which the second verifier can measure using an internal clock.

In step 220, the first verifier and the second verifier may jointly check to see if responses are valid, which indicates knowledge of a private identification key. For example, the second verifier may communicate the second challenge and second response to the first verifier. The first verifier may run a verification function Ver with the first and second challenges and first and second responses as input. If the verification function output is 1 (pass), the responses are deemed valid. If the verification function output is 0 (fail), the responses are deemed invalid.

In step 222, the first verifier and second verifier may jointly check to see if the receipt times are valid, such as satisfying a threshold which may depend on the distance between the first prover and second prover. For example, the second verifier may communicate the second challenge time and second receipt time to the first verifier. The first verifier may use a time check function that takes as input the first and second challenge time and first and second receipt time as input. If the timing check function output is 1 (pass), the timings are deemed valid. If the timing check function output is 0 (fail), the responses are deemed invalid.

In step 224, the round counter is checked to see if it is equal to n. If it is not, in step 226, the round counter may be increased by 1, and the process may return to step 210.

In step 228, a check is made to see if the responses and timings of all n rounds are deemed valid. If they are not, in step 230, the message is not authenticated.

If the receipt times are valid, in step 232, the first verifier checks to see if the receipt times of all n rounds are consistent with the prover selecting either the earlier response time or the later response time. For example, the first verifier checks that the receipt time of all n rounds is consistent with either the earlier response time or the later response time (i.e., the receipt time matches the sum of the earlier/later response time and the communication time between the second prover and second verifier).

An example of the verification is as follows. In step 216, the first verifier learns of the first receipt time, where it can measure the time the first response reaches using an internal clock. Using this first receipt time for each round, the first verifier can check if it is close to either (a) the sum of communication time from the first prover to the first verifier and the earlier response time, or (b) the sum of communication time from the first prover to the first verifier and the first response time.

The communication time from the first prover to the first verifier is the time taken for a message sent from the first prover to arrive at the first verifier. This communication time can be measured before the protocol begins or be pre-determined from specifications of the first prover electronic device the first verifier electronic device, and the communication channel between them. The earlier response time and later first response time are the selected response times from step 214. The first verifier selects an earlier response time if the time indicator bit is 0, and selects a later response time if the time indicator bit is 1.

If the response time for all rounds in this run are close to (a), it implies that the first prover has been consistently sending the first response in this run with an earlier response time. If the response time for all rounds in this run are close to (b), this implies that the first prover has been consistently sending the first response in this run with a later response time. If either case is true, the first verifier will accept that the timings for all n rounds are consistent.

In step 234 if the first receipt times are not consistent, in step 230, the message is not authenticated.

If the first receipt times for all n rounds are consistent with the prover selecting either the earlier first response time or the later first response time, in step 236, the first verifier may identify the time indicator bit chosen by the first prover based on the first receipt times for all n rounds. For example, if the first receipt time for all n rounds are consistent with an earlier first response time, the first verifier may identify the time indicator bit as 0 and if the first receipt time for all n rounds are consistent with a later first response time, the first verifier may identify the time indicator bit as 1. The first verifier may also record the identified time indicator bit as the next received codeword bit. For example, if the first verifier initializes an empty received codeword bitstring in step 204, the identified time indicator would be recorded as the next bit of the received codeword string. In other words, in the first run, the identified time indicator would be recorded as the first bit of the received codeword string, and in the second run, the identified time indicator would be recorded as the second bit of the received codeword string, and so on until the final bit of the codeword is reached.

In step 238, a check is made to see if the final bit of the codeword is reached. If the final bit of the codeword is not reached, in step 240, the first prover may select the next bit of codeword as the time indicator bit and proceed with a new run at step 208.

If the final bit of the codeword is reached, in step 242, the first verifier may decode the received codeword into a decoded message using the codebook.

In step 244, the first verifier may check if the decoded message matches the message it received in step 200. If the messages match, in step 246, the message is successfully authenticated. If not, in step 230, the message is not authenticated.

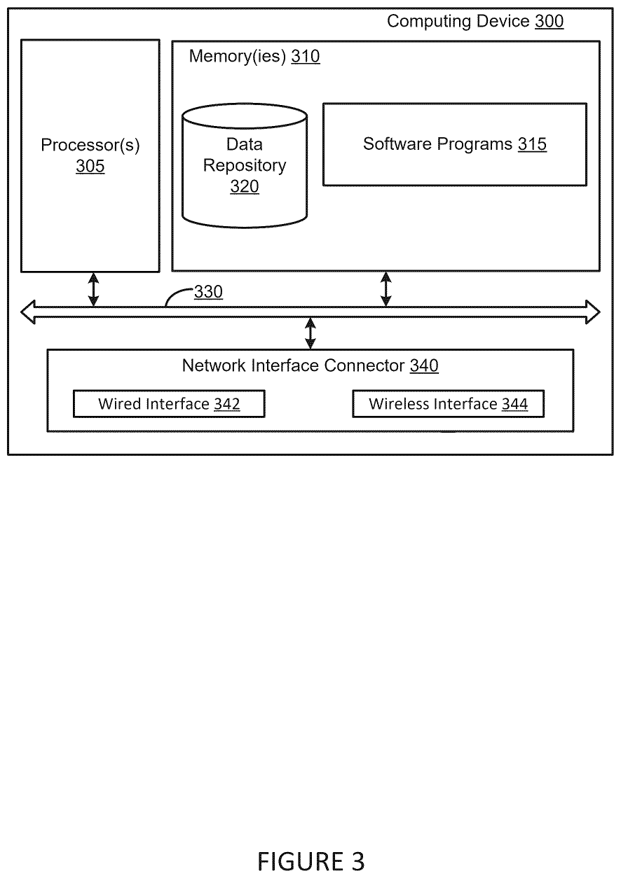

FIG. 3 depicts an exemplary computing system for implementing aspects of the present disclosure. FIG. 3 depicts exemplary computing device 300. Computing device 300 may represent the system components described herein. Computing device 300 may include processor 305 that may be coupled to memory 310. Memory 310 may include volatile memory. Processor 305 may execute computer-executable program code stored in memory 310, such as software programs 315. Software programs 315 may include one or more of the logical steps disclosed herein as a programmatic instruction, which may be executed by processor 305. Memory 310 may also include data repository 320, which may be nonvolatile memory for data persistence. Processor 305 and memory 310 may be coupled by bus 330. Bus 330 may also be coupled to one or more network interface connectors 340, such as wired network interface 342 or wireless network interface 344. Computing device 300 may also have user interface components, such as a screen for displaying graphical user interfaces and receiving input from the user, a mouse, a keyboard and/or other input/output components (not shown).

The disclosure of U.S. patent application Ser. No. 18/600,086 is hereby incorporated, by reference, in its entirety.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a first verifier, a message from a first prover, wherein the message is encoded into a codeword using a codebook, wherein the codeword comprises a plurality of bits;
for each bit in the codeword, one of the plurality of bits of the codeword is a time indicator bit, wherein the time indicator bit sets a response time, wherein the response time comprises an earlier response time or a later response time;
for a number of rounds:
sending, by the first verifier, a first challenge to the first prover;
receiving, by the first verifier and from the first prover, a first response to the first challenge at a timing based on the time indicator bit; and
checking, by the first verifier that the first response is valid and that a first receipt time of the first response is valid;
identifying, by the first verifier, a received time indicator bit from the first receipt times of all rounds;
generating, by the first verifier, a received codeword using the received time indicator bits;
decoding, by the first verifier, the received codeword using the codebook into a decoded message; and
verifying, by the first verifier, that the decoded message matches the received message.

2. The method of claim 1, wherein the number of rounds is based on a security parameter.

3. The method of claim 2, wherein the security parameter is based on a probability of an adversary passing timing and validity checks for the first responses.

4. The method of claim 1, wherein the step of checking, by the first verifier that the first response is valid and that a time of receipt of the first response is valid comprises:
jointly checking, by the first verifier and a second verifier, that the first response and a second response to a second challenge from second prover are valid and that a time of receipt of the first response and the second response are valid.

5. The method of claim 4, wherein the first challenge and the second challenge are based on a public identification key for which the first prover and the second prover share a private identification key.

6. The method of claim 5, wherein the first response comprises a first encrypted secret based on the private identification key and the first challenge, and the second response comprises a second encrypted secret based on the private identification key and the second challenge.

7. The method of claim 4, wherein a validity of the time of receipt of the first response and the time of receipt of the second response is based on a distance between the first prover and the second prover.

8. The method of claim 1, wherein the first verifier identifies the received time indicator bit from the first receipt times of all rounds and the earlier and later response times.

9. A system, comprising:
a first prover;
a first verifier in communication with the first prover;
a second prover; and
a second verifier in communication with the second prover;
wherein:
the first prover sends a message to the first verifier;
the first prover encodes the message into a codeword using a codebook, wherein the codeword comprises a plurality of bits;
for each bit in the codeword:
the first prover selects one of the plurality of bits of the codeword as a time indicator bit, wherein the time indicator bit sets a response time, wherein the response time comprises an earlier response time or a later response time;
for a number of rounds:
the first verifier is configured to send a first challenge to the first prover;
the second verifier is configured to send a second challenge to a second prover;
the first prover is configured to send a first response to the first challenge to the first verifier at a timing based on the time indicator bit;
the second prover is configured to send a second response to the second challenge to the second verifier; and
the first verifier and the second verifier are configured to jointly check that the first response and the second response are valid and that a first receipt time of the first response and the second response are valid;
the first verifier is configured to identify a received time indicator bit from the first receipt times of all rounds;
the first verifier is configured to generate a received codeword using the received time indicator bits;
the first verifier is configured to decode the received codeword using the codebook into a decoded message; and
the first verifier is configured to verify that the decoded message matches the received message.

10. The system of claim 9, wherein the number of rounds is based on a security parameter.

11. The system of claim 10, wherein the security parameter is based on a probability of an adversary passing timing and validity checks for the first responses and the second responses.

12. The system of claim 9, wherein the first challenge and the second challenge are based on a public identification key for which the first prover and the second prover share a private identification key.

13. The system of claim 12, wherein the first response comprises a first encrypted secret based on the private identification key and the first challenge, and the second response comprises a second encrypted secret based on the private identification key and the second challenge.

14. The system of claim 9, wherein a validity of the time of receipt of the first response and the time of receipt of the second response is based on a distance between the first prover and the second prover.

15. The system of claim 9, wherein the first verifier is configured to identify the received time indicator bit from the first receipt times of all rounds and the earlier and later response times.

16. A method, comprising:
sending, by a first prover, a message to a first verifier;
encoding, by a first prover, the message into a codeword using a codebook, wherein the codeword comprises a plurality of bits;
for each bit in the codeword:
selecting, by the first prover, one of the plurality of bits of the codeword as a time indicator bit, wherein the time indicator bit sets a response time, wherein the response time comprises an earlier response time or a later response time;
for a number of rounds, wherein the number of rounds is based on a security parameter:
receiving, by the first prover, a first challenge from the first verifier;
sending, by the first prover, a first response to the first challenge to the first verifier at a timing based on the time indicator bit, wherein the first verifier checks that the first response is valid and that a first receipt time of the first response is valid;
wherein the first verifier is configured to identify a received time indicator bit from the first receipt times of all rounds;
the first verifier is configured to generate a received codeword using the received time indicator bits, to decode the received codeword using the codebook into a decoded message, and to verify that the decoded message matches the received message.

17. The method of claim 16, wherein the first challenge is based on a public identification key for which the first prover shares a private identification key with a second prover, and wherein the first response comprises a first encrypted secret based on the private identification key and the first challenge.

18. The method of claim 16, wherein the first verifier is configured to identify the received time indicator bit from a sum of the first receipt times of all rounds and the earlier response time.

19. The method of claim 17, wherein the first verifier is configured to identify the received time indicator bit from the first receipt times of all rounds and the earlier and later response times.
